(19) United States
(12) Patent Application Publication
(10) Pub. No.: US 2009/0084197 A1
(43) Pub. Date: Apr. 2, 2009

(54) METHOD AND APPARATUS FOR MOUNTING A SENSOR

(76) Inventor: Raymond David Lohr, Buckinghamshire (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/280,111

(22) PCT Filed: Jan. 18, 2007
(86) PCT No.: PCT/GB2007/000172

§ 371 Date: Aug. 20, 2008

(30) Foreign Application Priority Data
Feb. 21, 2006 (GB) 0603439.1

(51) Int. Cl. G01L 1/22

(52) U.S. Cl. 73/862.627

(57) ABSTRACT

A sensor has a body having a tapered locking surface, and engages in a component with a mounting surface having a complementary taper to the tapered locking surface of the body. The body is positioned on the component with the tapered locking surface aligned with the mounting surface, and an axial force is applied to the body to drive the tapered locking surface into engagement with the complementary taper of the mounting surface. The body is then fixed relative to the component by swaging outwards a skirt on the body into engagement with a lower surface of the component.

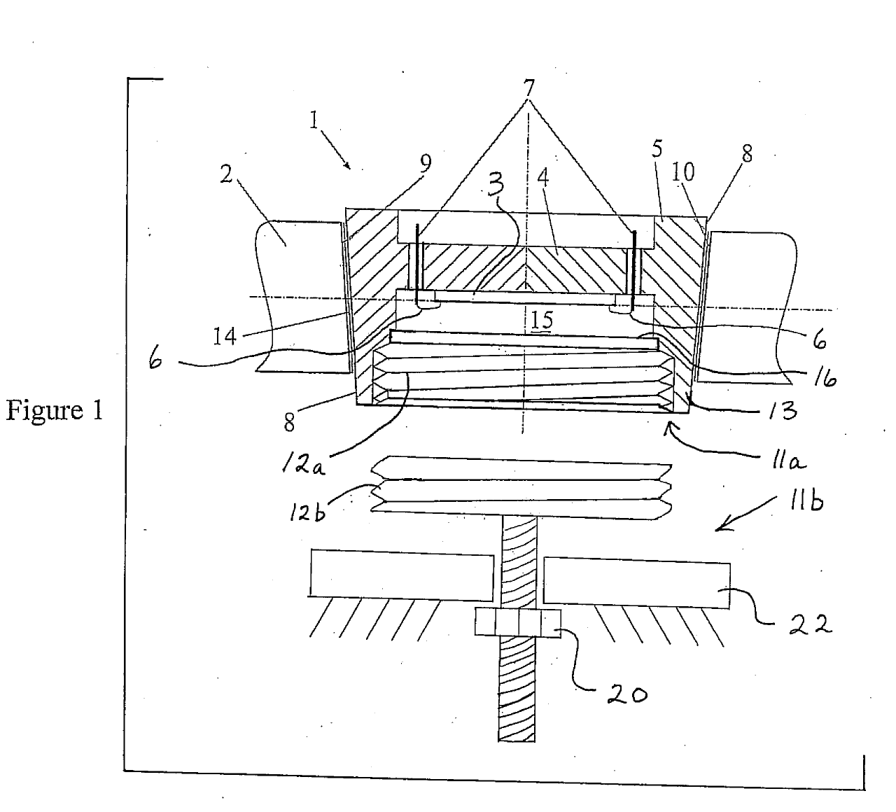

### BACKGROUND OF THE INVENTION

1. Field of the Invention

This invention relates to an improved method and apparatus for mounting a sensor on a body having a condition that is to be sensed. The invention is particularly applicable to mounting a strain gauge to a body whose deformation is to be measured, but the invention is not limited to this application and indeed may be utilised for the purpose of attaching any suitable sensor to any suitable body having a condition to be sensed by the sensor.

2. The Prior Art

It is common to mount strain sensors on structural components in order to detect or measure deformation of the component. The characteristics required for the mounting arrangement are well understood, but existing known arrangements do not simultaneously meet all the desired characteristics. In particular, it is recognised that the strain should preferably be transferred elastically with no microplasticity in the joint. The joint should also be substantially unaffected by environmental conditions, e.g. temperature and humidity and should be immune to degradation over time. The joint should be fatigue resistant over the prescribed operating range implying a requirement for low stress concentrations and minimal cracks or defects. At the same time, it is desirable that the joint could be manufactured easily, assembled quickly and readily serviced by replacement.

Historically, the most commonly used techniques for mounting strain sensors have been adhesive bonding and welding. Adhesive bonding meets the requirements for good strain transfer and modest stress concentration, but is susceptible to degradation in the longer term, particularly if exposed to extremes of temperature or high humidity conditions. Further, the cure times required for adhesive bonding may delay manufacturing processes and repairs are difficult or impossible.

The alternative technique of welding is fast and suits automated manufacture well and is substantially immune to long term degradation. However, welding induces stress concentrations and micro cracking which limit fatigue life. Again, repair may be difficult or impossible.

We have now devised a new method of securing a sensor, for example a strain gauge, to a structural component which obviates the disadvantages outlined above associated with traditional adhesive bonding and welding methods and is able to achieve or come close to achieving simultaneous fulfillment of the various desirable characteristics outlined above.

### SUMMARY OF THE INVENTION

In accordance with the first aspect of the present invention there is provided a method of mounting a sensor to a component, the method comprising: providing the sensor with a body having a tapered locking surface; providing the component with a mounting surface having a taper which matches the taper of the body locking surface; positioning the body in engagement with the mounting service; applying a predetermined axial force to the body to drive the tapered locking surface into engagement with the mounting surface; and fixing the body relative to the component.

In the preferred embodiment of the invention the body include means to be engaged by a puller to apply the required axial force to the body. The puller engaging means may comprise a fine screw thread provided on the body which can be engaged by a mating screw thread on a puller to exert the necessary axial force on the body. Means may be provided for restraining the puller relative to the component so that rotation of the puller will produce progressive engagement of the respective screw threads of the puller and the body will apply the required axial force to the body.

In order to prevent accidental backing off of the body from the position attained when the predetermined axial force is applied, an adhesive layer may be provided between the mating tapered surfaces of the body and the component. For example, an epoxy resin may be positioned between the components. The use of an epoxy resin at this point not only ensures that there is no back-off of the position of the body relative to the component, but also acts to reduce stress concentration. Additionally, or alternatively mechanical locking means may be provided. For example, if the body is provided with a large diameter screw thread for engagement with a puller with the result that a relatively thin skirt is defined around one end of the body, the skirt may be swaged outwardly to lock the body in position.

Preferably, the thermal and elastic characteristics of the body should be matched with those of the component to minimise stress concentration and relative movement which may occur as a result of mechanical deformation of the components or changes in environmental conditions (for example temperature).

In accordance with the second aspect of the present invention there is provided a sensor for mounting to a component, the sensor having a body having a tapered locking surface and the component having a mounting surface with a taper which matches the taper of the body locking surface, wherein the body includes means for engaging a tool for applying a predetermined axial force to drive the tapered locking surface into engagement with the tapered mounting surface, and including fixing means for fixing the body relative to the component.

Although the present invention is not limited to any particular application, it does provide a particular advantage when used to secure a strain gauge to a plate. This is because the method enables the sensor to be positioned at a position within the thickness of the plate. More particularly, it enables the sensor to be positioned substantially on the neutral axis of the plate. If the plate is deformed by bending there is substantially no bending stress in the neutral axis so that the strain gauge can effectively reject stress due to plate bending as a result of its position. In contrast, in traditional techniques where strain gauges are applied to the upper or lower surface of a plate it was necessary to take account of bending stresses if a measurement of non-bending stresses was required. This could, for example, be done by applying strain gauges to both the upper and lower surfaces of the plate and summing the outputs of the two strain gauges in order to eliminate measurements resulting from bending stress. The present invention obviates the need for such techniques by allowing physical positioning of the strain gauge in a position where it will be substantially isolated from bending stress.

### BRIEF DESCRIPTION OF THE DRAWING

The invention will be better understood from the following description of a preferred embodiment thereof, given by way of example only, reference being had to the accompanying drawing wherein the single FIGURE illustrates schematically in cross-section a preferred embodiment of the present invention.

### DETAILED DESCRIPTION OF THE PREFERRED EMBODIMENTS

Referring now to the drawing there is shown a sensor 1 mounted to a component 2. In the illustrated embodiment of the invention the sensor 1 is a strain gauge. It is to be understood, however, that the invention is not limited to such sensors and is applicable to the mounting of any sensor which can be provided with a body having the necessary form for engaging a tapered mounting surface in the manner required by the present invention. In the illustrated embodiment of the invention the component 2 is in the form of plate. However, it is again to be understood that the invention is not limited to such components and may, on the contrary, be applied to any component which can be furnished with a tapered mounting surface for engagement by a tapered locking surface in the manner required by the present invention.

In the illustrated embodiment the sensor 1 is a SAW (Surface Acoustic Wave) device having a quartz die 3 secured to a bridge 4 which forms part of a sensor body 5. The arrangement is such that deformation of the body 5 will result in corresponding deformation of the quartz die 3 with a resultant change in the SAW characteristics of the device as will be understood by those skilled in the art. Electrical connections 6 connect the SAW device to pins 7 for onward connection to a suitable measuring circuit or for connection to an antenna for wireless operation. The quartz die 3 is located within a chamber 15 defined within the sensor body 5. The chamber 15 is closed by a lid 16. Preferably, the chamber 15 is hermetically sealed.

The body 5 includes a tapered locking surface 8. The angle of taper is not critical to the present invention but will be in a range that will lock when engaged with a mating taper 9 provided on a mounting surface 10 formed on the component 2.

The body 5 is provided, at the lower end thereof as illustrated in the drawing, with a socket 11a formed with a fine screw thread 12a. The diameter of the socket 11a is large relative to the overall diameter of the body with the result that a relatively thin skirt 13 of body material surrounds the socket 11a. The screw threads 12aof the socket 11a are adapted to be engaged by a complementary screw thread 12b on a puller 11b. The puller preferably includes a screw threaded member in the form of a rod, bolt or screw which can be screwed home into the screw threads 12a, a nut 20 that runs on the screw threaded member, and means 22 for holding the nut 20 a predetermined distance from the surface of the component 2 and for reacting forces from the nut onto the surface of the component 2 adjacent the sensor 1. Thus, in order to exert the required pull on the body 5 the screw threaded member 12b is screwed into the thread 12a and the nut 20 is screwed down the screw threaded member towards the body 5. Because movement of the nut towards the component 2 is prevented, the effect of rotating the nut 20 will be to pull the screw threaded member 12a and with it the body 5 towards the nut 20. The magnitude of the axial force may be detected by means of a suitable strain measuring device incorporated within the puller or, depending on the accuracy with which the force must be determined, can be determined by measuring the torque applied to the nut that runs on the screw threaded member of the puller. The objective, in either event, is to apply a predetermined force to the body 5 to seat the tapered locking surface 8 firmly and predictably into a locked relationship with the tapered surface 9.

If desired, a suitable bonding material 14, for example an epoxy resin, may be positioned between the confronting surfaces 8,9. The effect of the epoxy resin is both to reduce stress concentration at the interface between the respective component and to provide a bond which will resist backing off movement of the body 5 from the position into which it has been moved by the force applying means.

Additionally or alternatively to the use of a bonding agent 14, means may be provided for mechanically locking the body to the component. Such means could comprise outwardly swaging of the skirt 13 or other suitable means.

The above described mounting method and apparatus results in an arrangement in which the sensor is clamped by radial and circumferential stresses. Stress concentrations are low and by suitable choice of materials the stresses at the interface between the components caused by mechanical deformation and thermal effects can be minimised. Manufacture is straightforward and if it is envisaged that service replacement of the sensor will be necessary the locking arrangement can be designed to permit easy removal and replacement of the sensor.

1-12. (canceled)

13. A method of mounting a sensor to a component, comprising the steps of:
providing the sensor with a body having a tapered locking surface;
providing the component with a mounting surface having a complementary taper to the tapered locking surface of the body;
positioning the body on the component with the tapered locking surface aligned with the mounting surface;
applying an axial force to the body to drive the tapered locking surface into engagement with the complementary taper of the mounting surface; and
fixing the body relative to the component.

14. The method according to claim 13, wherein the body includes means which, in use, can be engaged by a puller for applying said axial force to the body.

15. The method according to claim 14, wherein said means is one of a male and female thread, the puller being provided with the complementary other of the male and female thread, by means of which the puller may be secured to the body.

16. The method according to claim 15, further including means for restraining the puller relative to the component such that rotation of the puller relative to the body in order to engage said threads draws the body towards the puller in order to achieve the required axial force.

17. The method according to claim 13, further comprising the step of providing a layer of adhesive between the mating tapered surfaces of the body and the component in order to fix the body relative to the component.

18. The method according to claim 13, wherein the step of fixing the body relative to the component includes providing mechanical locking means.

19. The method according to claim 18, wherein said step of fixing the body relative to the component comprises swaging outwardly a skirt provided on the end of the body which extends through the component so that said skirt engages an axial face of the component, thereby preventing the body from retracting back through the component.

20. A sensor for mounting to a component comprising:
a body having a tapered locking surface and the component having a mounting surface with a taper which complements the tapered locking surface of the body;
wherein the body includes (i) means for being engaged by a tool for applying an axial force to drive the tapered locking surface into engagement with the tapered mounting surface, and (ii) fixing means for fixing the body relative to the component.

21. The sensor according to claim 20, wherein the mounting surface of the component extends across the neutral axis of bending of the component, the body including a mounting platform for receiving the sensor which is positioned in the body so as to lie on the neutral axis of the component when the tapered surfaces are engaged.

22. The sensor according to claim 21, wherein the component is a plate and the sensor is a strain sensor.

23. The sensor according to claim 20, wherein the body includes a skirt which extends beyond the tapered mounting surface of the component when the two tapered surfaces are engaged, wherein the skirt is swagable outwards in order to engage a surface of the component and lock the tapered surfaces in engagement with each other.

24. The sensor according to claim 20, wherein an adhesive layer is applied to said tapered surfaces in order to lock them together.
